(19) United States
(12) Patent Application Publication
(10) Pub. No.: US 2026/0111835 A1
(43) Pub. Date: Apr. 23, 2026

(54) Augmented Reality Software Application for Heads-up and Hands-free Delivery

(71) Applicant: ANDRE BYERS, Washington, DC (US)

(72) Inventor: ANDRE BYERS, Washington, DC (US)

(21) Appl. No.: 19/356,120

(22) Filed: Oct. 12, 2025

Related U.S. Application Data
(60) Provisional application No. 63/709,372, filed on Oct. 18, 2024.

(51) Int. Cl. G06Q 10/083; G01C 21/00; G01C 21/26; G06F 3/16

(52) U.S. Cl. CPC G06Q 10/08355; G01C 21/265; G01C 21/3804; G06F 3/167

(57) ABSTRACT

A composition of computer language provides a software application. The computer language of the software application can provide an improvement to augmented reality glasses that enables users to make safer and faster deliveries of persons and/or goods. A composition of computer language provides a software application that enables users to use augmented glasses to keep their head up and hands-free for safer driving while interacting with the software application itself, navigating to locations, and speaking with relevant parties. Drivers and couriers utilizing said software application to keep their head up and hands free also increases their efficiency and speed for increased profitability.

### CROSS-REFERENCE TO RELATED APPLICATIONS

This application claims priority to provisional application App. No. 63/709,302 filed Oct. 18, 2024 the contents are incorporated by references herein.

### FIELD

The present disclosure generally relates to a software application, and particularly relates to a software application for augmented reality glasses that enable constant heads-up; hands-free deliveries that improve safety, efficiency, and speed.

### BACKGROUND

The means to transport goods and passengers are rapidly evolving and growing—including the increased use of taxi, ride-hail, app-based and on-demand food delivery, as well as “last mile” delivery services. This is especially true for the delivery of goods. According to the US Census Bureau News¹, eCommerce accounted for 14.6% of total sales in 2022 and continues to rapidly rise. ¹ https://www2.census.gov/retail/releases/historical/ecomm/22q4.pdf

The rapid rise in demand for the transportation of goods and passengers have created a deluge of vehicles of all sizes and speeds traversing the public domain. Most streets and walkways were not designed for this multi-modal cross-section of people and vehicles with residents of densely-populated urban areas bearing the brunt of safety risks.

The local transport of passengers and goods is an enterprise based on volume and speed. To be profitable, businesses must master both—with almost all on-demand services maintaining negative operating budgets. The ability to provide delivery service at a cost most consumers are willing to pay has been extremely elusive with most companies relying on the infusion of investor dollars to stay afloat while continuing to pursue profitability.

### SUMMARY

The following summary presents a simplified summary of certain features. The summary is not an extensive overview and is not intended to identify key or critical elements.

In accordance with the teachings of the present disclosure, a composition of computer language in the form of a software application can provide an improvement to augmented reality glasses.

An aspect of the present disclosure provides a composition developed of computer language of a software application to improve augmented reality glasses for user's ability to constantly keep their head up and hands free to make deliveries (of persons and/or goods) safer and faster. An aspect of the present disclosure includes a visual representation of the user's route (inclusive of all relevant data—pickup/delivery addresses, points of contact, telephone numbers, anticipated arrival times, etc.).

Another aspect of the present disclosure includes heads-up navigation with turn-by-turn instructions (inclusive of visual and audible cues).

Another aspect of the present disclosure includes an Artificially Intelligent Assistant (“AIA”) that responds to a “wake word” and follows the user's voice commands. In yet another aspect, the AIA's responses to voice commands include, but are not limited to, activating the heads-up navigation, putting the entire navigation-view “to sleep” so the user's view is unobstructed, “awakens” the navigation-view when requested by the user, reports the ETA for the next stop, “zooms in” to show street-level guidance on the navigation's map, and provides an aerial “overview” of the entire route on the navigation's map. In yet another aspect, the AIA's responses to voice commands also include, but are not limited to, taking a “proof of delivery” photograph, calling a recipient, video conferencing dispatch, adding a note to an order, and completing an order (automatically sending “Order Completed” notifications to relevant persons).

Another aspect of the present disclosure provides an alternative to handheld devices that provide navigation systems that require the user to look down or away from the road (causing a safety risk) by providing an alternative that is completely voice activated so there is no need to look away from the road to interact with the application or see where is the next turn on the handheld device.

Another aspect of the present disclosure provides an alternative to handheld devices used by drivers and couriers to manage pickup and deliveries (causing a lag in time) by providing an alternative that is completely voice activated so users can use their hands to simultaneously search for and carry packages while the app presents the relevant information needed for the user to find the relevant package and deliver it to the correct place.

Another aspect of the present disclosure provides an alternative to handheld devices used by drivers and couriers to call recipients (causing a lag in time) by providing an alternative that is completely voice activated so users can use their hands to drive or search for and carry packages while the app calls the needed recipient. In yet another aspect, by using voice commands instead of tapping buttons on a handheld device, the user is able to save time by using their hands to drive or search for and carry packages while the app video calls dispatch so dispatch is able to see what the user sees for the sake of providing guidance.

Another aspect of the present disclosure provides an alternative to handheld devices used by drivers and couriers to take “proof of delivery” photographs (causing a lag in time and decreased safety) by providing an alternative that is completely voice activated so users can use their hands to carry packages (especially heavy ones) while the app takes the proof of delivery photograph.

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

FIG. 1 is a perspective view of the software application offering the user options to view the current route or to start the current route.

FIG. 2 is a perspective view of the software application's route, in list form, for the current user. It notes whether or not the user is doing a pickup or delivery, denoted by “P” or “D.” It also identifies the address and expected time of said pickup or delivery, as well as the name of the vendor and customer.

FIG. 3 is a perspective view of the software application providing the user detailed information for the next stop and offering the user options to “Start Navigation” to the next location, start service at said location, or to reject the order completely.

FIG. 4 is a perspective view of the software application's heads-up navigation.

FIG. 5 is a perspective view of the software application after the user has decided to start service at the location. The user is offered the ability to take a “proof of delivery” photograph, add a note, call the recipient, video-call dispatch, or complete the delivery and advance to the next order.

FIG. 6 is a perspective view of pre-populated “notes” that are available to the user after having decided to reject an order.

FIG. 7 is a perspective view of the software application's camera function for “proof of delivery” photographs.

FIG. 8 is a perspective view of the software application's call function for calling customers and/or vendors.

FIG. 9 is a perspective view of the software application's video-call function for conducting video calls with dispatch, customers, and/or vendors.

### DETAILED DESCRIPTION

The features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings.

The present specification as well as various commercial and consumer products may provide an alternative to handheld devices (e.g. cell phones) by providing augmented reality glasses with a hands-free option for the user. The augmented glasses may comprise a combination of computer language designed as a software application that manages the user's route, displays relevant information, provides navigational guidance, takes “proof of delivery” photographs, makes calls and video-calls, and executes the user's voice commands.

The following example will illustrate a method of utilizing the software application. In accordance with the teachings of the present disclosure, a composition of computer language may be formed to create a software application. In accordance with the teachings of the present disclosure, the composition of computer language for the software application can improve augmented reality glasses for user's ability to constantly keep their head up and hands free to make deliveries (of persons and/or goods) safer and faster. An aspect of the present disclosure is to provide a software application that manages the user's route, displays relevant information, and executes the user's voice commands through augmented reality glasses for increased safety, efficiency, and speed. The augmented reality glasses (or “hardware”) to be used in conjunction with the software include an on-device camera, microphone, speakers, processor, GPS, Bluetooth, battery, and display. The augmented reality glasses are built to be worn by the user and untethered to another device. Using glasses as a form factor instead of handheld devices permit the user to maintain an attentive, heads-up posture while making deliveries.

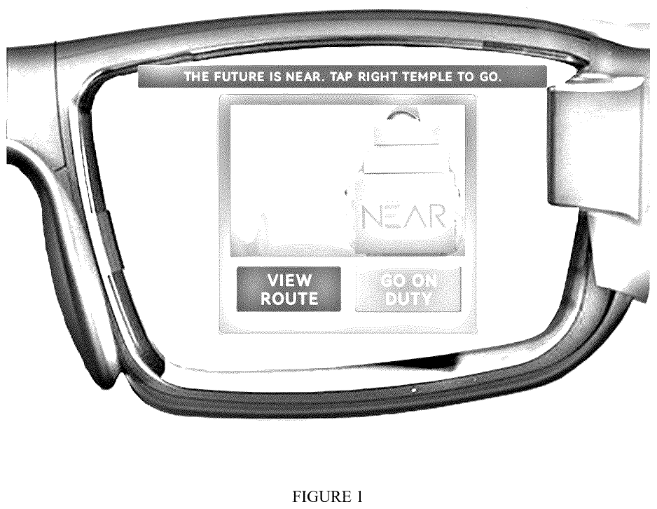

FIG. 1 is a perspective view of the software application offering the user the options to view the current route or to start the current route. The user's route can be installed on the device remotely via internet connection or it can loaded onto the device via a cord connection to a computer. Once the route is loaded onto the device, the user is able to click “View Route” and see an aerial map of the entire route (not shown) or the user can click “Go on Duty” and start on the first order (see next step). Along each step of the process, it must be noted that the user can either select the virtual buttons presented in their view (e.g. “View Route” or “Go on Duty”) by using their finger to swipe the arm of the glasses forwards/backwards and then tapping the same arm to “click” the selected button, or the user can utter a “wake word” (e.g. “Wake up glasses”) for the Artificial Intelligent Assistant (“AIA”) to answer and initiate voice commands (e.g. “Go on duty”).

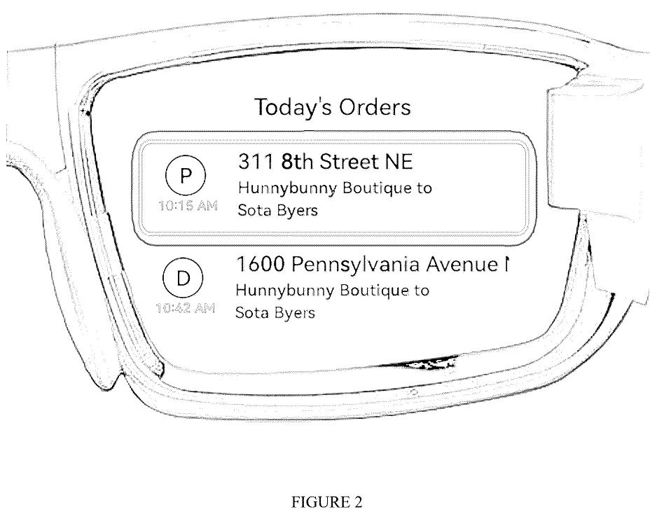

After the user selects the “Go on Duty” button, their route appears in a sequential order. If needed, this route would have already been optimized based on distance and time traveled by the software's companion application that operates on the user's (or Administrator's) computer. FIG. 2 is a perspective view of the user's route (in list form) as seen through the augmented reality glasses. The user can scroll through this list using voice commands (e.g. “go down”) and then instruct the AIA to “Select” the desired order or manually select the desired order with one's finger on the glasses' arm.

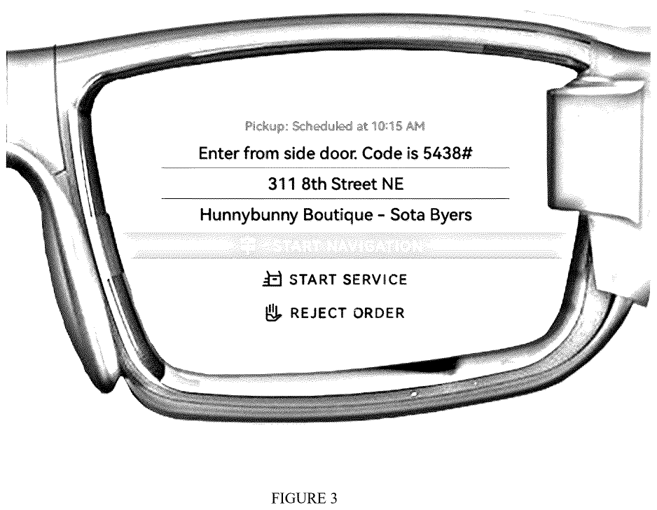

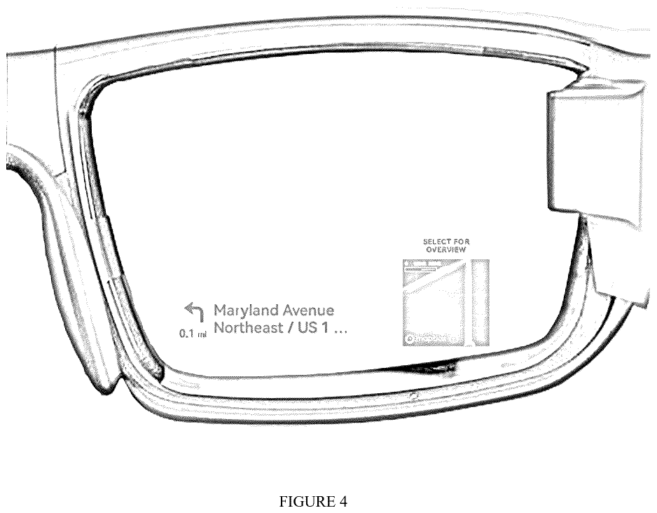

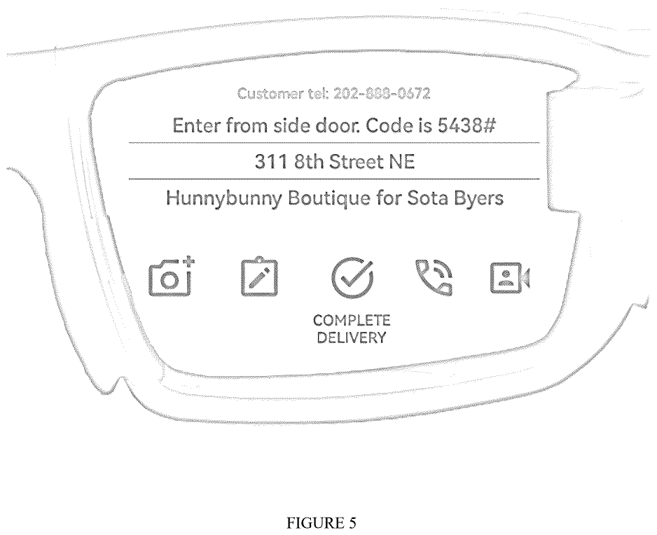

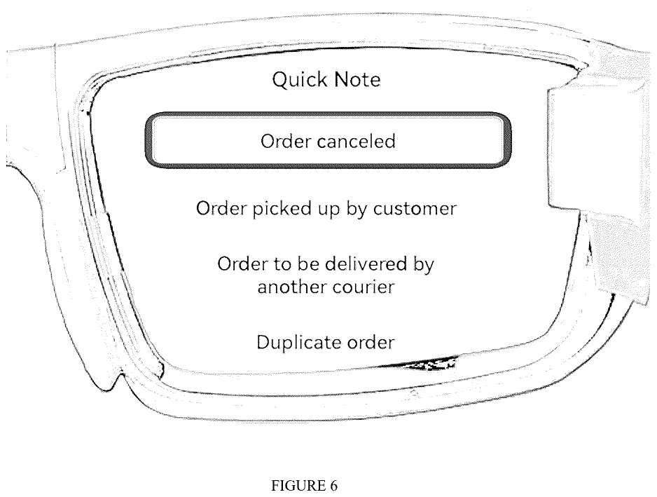

After the user selects the desired order, detailed information regarding that order appears as well as virtual buttons to navigate to the order's location, start service, or reject the order. FIG. 3 is a perspective view of this information as seen through the augmented reality glasses. If the user chooses to “Start Navigation,” then the user is taken to the software application's heads-up navigation (FIG. 4). If the user chooses to “Start Service,” then the user is taken to tools needed to complete the delivery (FIG. 5). If the user chooses to “Reject Order,” then the user is presented with a list of pre-populated “notes” to add that explain why the order was rejected (FIG. 6).

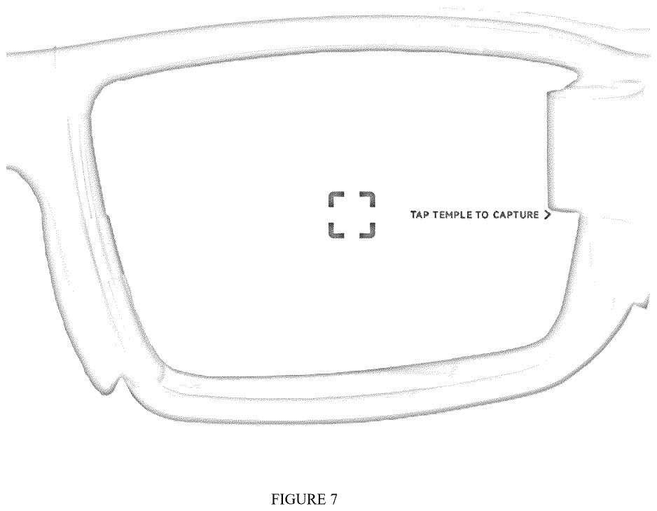

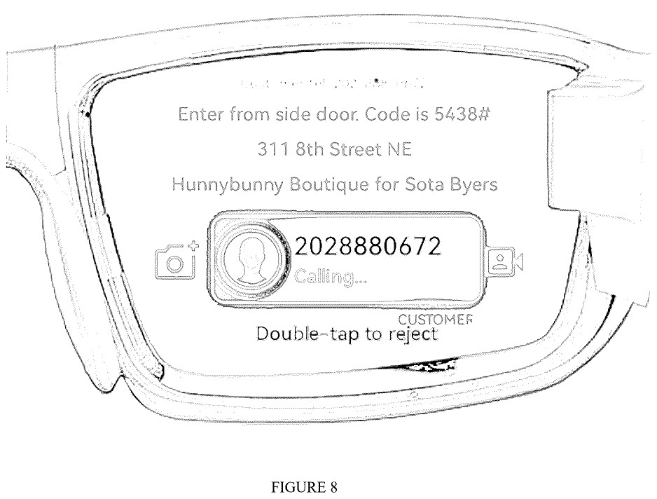

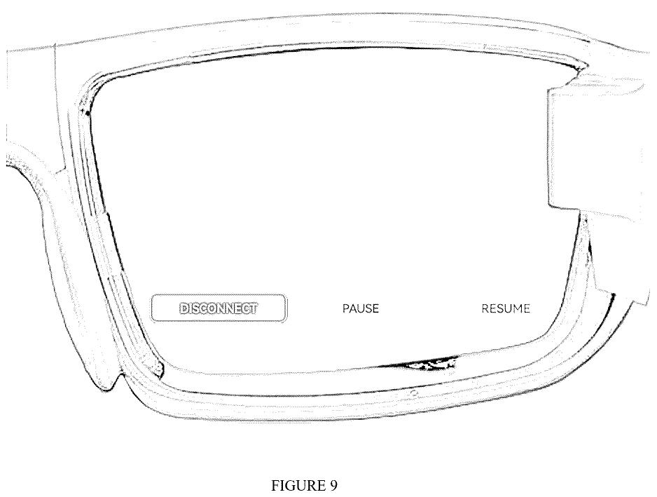

FIG. 5 is a perspective view of the software application after the user has decided to start service at the location. The user is offered the ability to take a “proof of delivery” photograph, add a note, call the recipient, video-call dispatch, or complete the delivery. If the user decides to add a proof of delivery photograph, then the user is taken to the software application's camera (FIG. 7). If the user chooses to “Add a Note” then the user is presented with a list of pre-populated “notes” to add (not shown). If the user chooses to call the recipient, then the software application dials out to the number associated with the recipient (FIG. 8). If the user chooses to video-call dispatch so that dispatch can see what the user sees, then the software application connects the two persons so the user can hear and speak with dispatch while showing dispatch said user's view (FIG. 9). If the user “Completes Order,” then notifications are automatically sent out (including “proof of delivery” photographs and notes) to all of the relevant parties. Subsequently, the user's route advances to the next order and the process begins again until the route is exhausted.

What is claimed is:

1. An improvement of augmented reality glasses made of a software application, comprising of a composition of computer language.

2. The improvement of augmented reality glasses according to claim 1, wherein the software application composition further comprises about:
a. A local repository of names, addresses, telephone numbers, and order “notes” that are displayed through the augmented reality glasses in sequential order so to inform the user where to pickup and/or deliver persons or goods;
b. Said local repository's ability to communicate with a centralized repository (managed by a dispatch and/or administrator) for the sake of receiving an optimized route, receiving updates to its existing route, sending updates regarding the status of its orders, and sending notifications to relevant parties (e.g. customers, vendors, etc.);
c. A heads-up navigation with visual turn-by-turn instructions, voice turn-by-turn instructions, and a visual representation of the route the user is currently following is overlayed on a map;
d. An ability to manage the on-device camera for pictures, videos, and video-streams;
e. An ability to manage the on-device microphone and speakers to initiate phone calls and video-calls;
f. An ability to add notes to each pickup and delivery for their inclusion in the notifications that are automatically sent to relevant parties;
g. An Artificial Intelligence Assistant that enables users to complete tasks without using their hands by completing requested tasks through voice commands.
